(19) United States
(12) Patent Application Publication
(10) Pub. No.: US 2008/0170576 A1
(43) Pub. Date: Jul. 17, 2008

(54) METHOD, COMPUTER PROGRAM PRODUCT, AND APPARATUS FOR OPTIMALLY DEPLOYING ISCSI SESSIONS AUTOMATICALLY

(75) Inventors: Jesse P. Arroyo, Rochester, MN (US); Josep Cors, Rochester, MN (US); Mark H. Goff, Stewartville, MN (US); Michael A. Migliacio, Rochester, MN (US); Randall S. Nelson, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/623,836

(22) Filed: Jan. 17, 2007

(51) Int. Cl. H04L 12/56

(52) U.S. Cl. 370/395.52

(57) ABSTRACT

An optimal configuration of Internet Small Computer Systems Interface (iSCSI) sessions is automatically determined. A number of iSCSI target ports and a number of iSCSI initiator ports in a configuration are determined, and an ideal session count is determined for each iSCSI initiator port in order to maximize efficiency. All iSCSI initiator ports are traversed, and a determination is made which iSCSI initiator ports have less than the ideal session count. For those iSCSI initiator ports that have less than the ideal session count, the iSCSI target ports that are currently not logged into an iSCSI initiator ports that have fewer sessions than the ideal sessions. The steps of finding and attempting are repeated until a current total number of active sessions equals the number of iSCSI target ports.

### BACKGROUND

This invention relates generally to iSCSI session management, in particular to optimally deploying iSCSI sessions automatically.

The Small Computer System Interface (SCSI) is a set of standard electronic interfaces that allows personal computers to communicate with peripheral hardware such as disk drives, tape drives, CD-ROM drives, printers, and scanners faster and more flexibly than previous interfaces. Internet Small Computer Systems Interface (iSCSI) protocol is a protocol that defines how to run a Small Computer System Interface (SCSI) protocol over an IP network. In iSCSI, the network endpoints are called the iSCSI initiator port (physically connects a user of storage) and the iSCSI target port (physically connects a provider of storage).

An iSCSI initiator port sends a login to attempt to create an iSCSI session through a specific iSCSI target port. The login may succeed or fail. A successful login establishes an active session. An iSCSI initiator port system can use an active session to access storage associated with the iSCSI target port.

In complex networks, some iSCSI target ports can be reached only by some of the iSCSI initiator ports. Login attempts from other iSCSI initiators will fail to establish an active session. For a system with multiple iSCSI initiator ports that has knowledge of multiple pertinent iSCSI target ports, a decision is required regarding which iSCSI initiator port to use to establish a session with each known pertinent iSCSI target port.

In previous solutions to this problem, a program running on the system with iSCSI initiator ports provided a way for human to create and manage iSCSI sessions manually. Upon subsequent initiator system startups, the iSCSI initiator port system would typically attempt to reestablish the same sessions used before. However, there are cases where the human user must intervene, such as initial setup. Also, a human user must intervene when hardware containing the previous session information must be replaced. Also, a human user must intervene when the number of iSCSI initiator ports changes, when the number of iSCSI target ports changes, and when the same iSCSI initiator port system hardware is time-shared between different users with different iSCSI target port requirements.

Requiring a human to manually manage the sessions can create problems. For example, the user must know enough about iSCSI to understand the identifiers and rules involved in connection management. This hurts ease of use. Erroneously removing a session causes the iSCSI initiator port system to lose access to storage devices, which may cause critical data to become inaccessible. Creating multiple sessions to the same iSCSI target port can cause the same storage device to appear multiple times (looking like multiple devices) on the iSCSI initiator port system. This can lead to data integrity issues. Also, manually created connections might not be optimally balanced over the iSCSI initiator ports available in the ecosystem. For example, one iSCSI initiator port might end up being used for three sessions, while another iSCSI initiator port is used for only one session.

There is a need for a technique for automatically deploying iSCSI sessions in an optimal manner.

### SUMMARY

According to exemplary embodiments, a method, computer program product, and apparatus are provided for determining an optimal configuration of Internet Small Computer Systems Interface (iSCSI) sessions. A number of iSCSI target ports and a number of iSCSI initiator ports in a configuration are determined, and an ideal session count is determined for each iSCSI initiator port in order to maximize efficiency. All iSCSI initiator ports are traversed, and a determination is made which iSCSI initiator ports have less than the ideal session count. For those iSCSI initiator ports that have less than the ideal session count, the iSCSI target ports that are currently not logged into an iSCSI initiator port are found, and an attempt is made to establish missing sessions using iSCSI initiator ports that have fewer sessions than the ideal sessions. The steps of finding and attempting are repeated until a current total number of active sessions equals the number of iSCSI target ports.

### BRIEF DESCRIPTION OF THE DRAWINGS

These features and advantages of exemplary embodiments will become further apparent to those skilled in the art from the following detailed description taken in conjunction with the accompanying drawings wherein:

FIG. 1 illustrates an exemplary method for optimally deploying iSCSI sessions according to an exemplary embodiment.

FIG. 2A illustrates an exemplary server environment with the technique for deploying iSCSI sessions not applied.

FIG. 2B illustrates an exemplary server environment with the technique for deploying iSCSI sessions applied according to exemplary embodiments.

FIG. 3 illustrates an exemplary system for optimally configuring iSCSI sessions according to an exemplary embodiment.

### DETAILED DESCRIPTION OF EXEMPLARY EMBODIMENTS

According to exemplary embodiments, a set of heuristics is used to determine the most efficient configuration possible for managing iSCSI sessions and implement this configuration. More specifically, according to an exemplary embodiment, a technique is provided for efficiently and automatically managing iSCSI sessions in an ‘ecosystem’ including a system having “m” iSCSI initiator ports connected via an IP network to “n” iSCSI target ports. The values for “m” and “n” must each be at least 1, but increasing “m” and “n” increases the total bandwidth available between the iSCSI initiator port system and the iSCSI target port. The iSCSI initiator port system has knowledge of pertinent iSCSI target ports including appropriate address and identifier information needed to create sessions to them. Also, it is assumed that each storage device is accessible through only one iSCSI target port. Login attempts are serialized in a manner that guarantees that the iSCSI initiator port system never has more than one active session through a given iSCSI target port.

According to an exemplary embodiment, an auto starting program may be used to create and manage the iSCSI sessions. The program safely determines the most effective session configuration based on “n” and “m” and configures it automatically, without any user intervention. This allows the user to access storage devices through iSCSI target ports with the sessions optimally balanced over the iSCSI initiator ports.

First, it should be noted that each initiator object (iSCSI initiator port) contains a count of how many iSCSI target ports it is currently logged into.

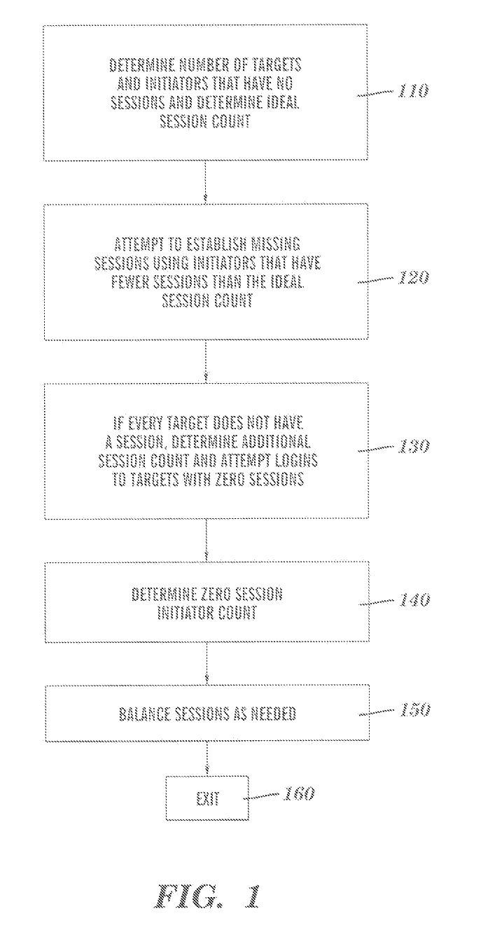

FIG. 1 illustrates an exemplary method for automatically determining an optimal configuration of iSCSI sessions. In step 110, the number of iSCSI target ports (targets) and iSCSI initiator ports (initiators) which currently have no iSCSI sessions is determined, and the “ideal session count” (a count of the number of sessions each iSCSI initiator port should contain in order to maximize the efficiency of the optimal configuration) is calculated. The “ideal session count” is found by taking the total number of valid iSCSI target ports and dividing it by the total number of valid iSCSI initiator ports (targets/initiators), and rounding the result down to either the nearest integer or one, whichever is greater. Although not shown in FIG. 1 for simplicity of illustration, the procedure may be exited if there are no initiators added to the solution since the last time the procedure was run, and all targets currently have a session associated with them.

Assuming all targets do not have a session currently associated with them, step 120 is performed to attempt to make the number of sessions equal to the number of targets. As part of this step, all valid initiators are traversed, and a determination is made whether or not each initiator has a number of sessions equal to the ideal session count. For all initiators that have less than the ideal session count, the targets that are currently not logged into an initiator are found, and an attempt to establish missing sessions using initiator ports that have fewer sessions than the ideal session count. This process is repeated until the current total number of active sessions equals the number of targets, or there are no more eligible iSCSI initiator ports or target ports to try.

In some cases, step 120 will not result in creation of a session for every target. In these cases, an “additional session count” (the total number of valid targets minus the number of active sessions) needs to be determined at step 130. Starting from the last initiator in the current configuration, any initiator that can currently accept logins is found. Then, any targets which currently have no sessions are found, and login attempts are sent between the initiators and the targets found to have zero sessions. Each time a login is successful, the “additional session count” is decremented. This process is continued until the additional session count is zero or attempts have been made to send logins from each initiator. Note that if the iSCSI initiator ports and target ports are connected via multiple networks rather than a single network, it may not possible to log into an iSCSI target port from an initiator port without creating an unacceptable redundant connection, so there may be cases where the “ideal” scenario cannot be reached due to hardware configurations.

At this point, every target should have a session. Now, at step 140, a determination is made whether there are any initiators left that are not logged into any targets (the “zero session initiator count”). If so, the sessions need to be balanced.

At step 150, the sessions are balanced by first finding an initiator port with a greater number of sessions than the ideal session count (assuming there are initiators without sessions in the configuration, this should be the case). Then, an iSCSI target port currently linked to that initiator is found, making sure that the target is not providing critical OS storage to devices, such as a paging device (which cannot safely be removed without risking a crash). Once this target is found, the Logical Unit Numbers (LUNs) identifying SCSI devices (storage devices) may be locked on the target to prevent reading/writing operations that could corrupt data, and the session may be removed. Then, the iSCSI target port may be logged into the initiator with zero sessions, and the “zero session initiator count” may be decremented. This process is repeated until all iSCSI initiator ports contain sessions. The procedure is then exited at step 160.

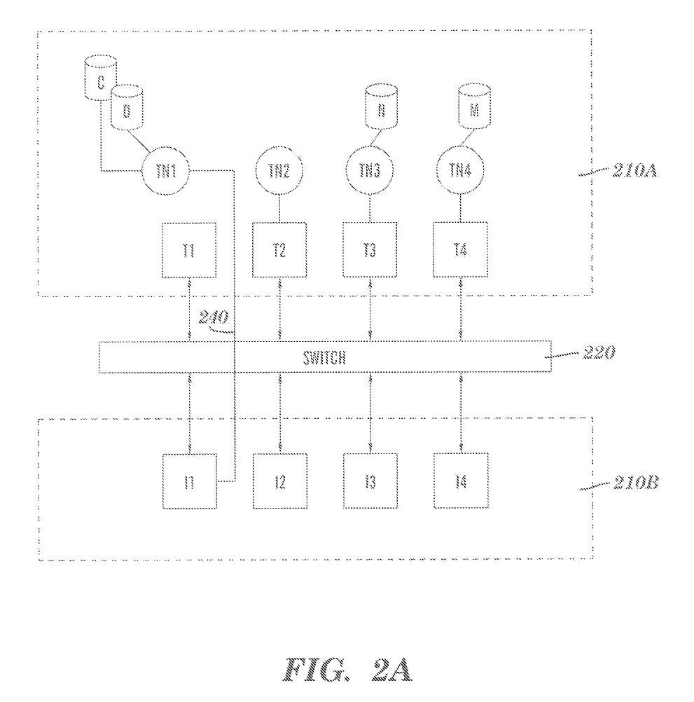

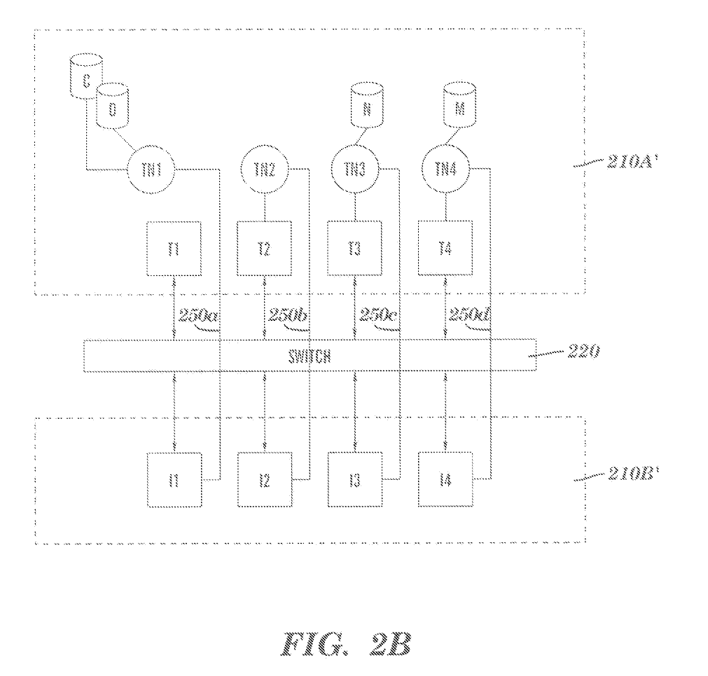

To demonstrate the effectiveness of the technique described herein, FIG. 2A shows a server environment as it may exist before application of the session deployment technique described herein, and FIG. 2B shows an example of a server environment with the session deployment technique implemented according to an exemplary embodiment. In FIGS. 2A and 2B, there are storage servers 210A, 210B and systems 210A′, 210B′, respectively. The storage servers and systems are connected via a switch 220. There are four iSCSI initiator ports, labeled I1, I2, I3, and I4, located in systems 210B and 210B′. These are physically connected to the switch 220. There are also four iSCSI target ports, labeled T1, T2, T3, and T4, located in storage servers 210A and 210A′ and physically connected to the switch 220. The solid lines 240, 250a, 250b, 250c, and 250d indicate sessions that may be established between the iSCSI initiator ports and the iSCSI target ports so that the systems 210B and 210B′ can access storage/SCSI devices associated with the iSCSI target ports.

In FIG. 2A, which represents a conventional server environment, a system would only have access to storage devices (C, D) associated with a pre-existing session, as indicated by the sold line 240. Other configurations are possible, such as storage devices C, D being hard drives in the system instead of storage devices in a storage server. FIG. 2B illustrates a server environment after a session deployment technique has been applied, according to an exemplary embodiment. As can be seen from FIG. 2B, the system has access to all pertinent storage/SCSI devices (C, D, N, M) in the storage server, as indicated by the solid lines 250a, 250b, 250c, and 250d.

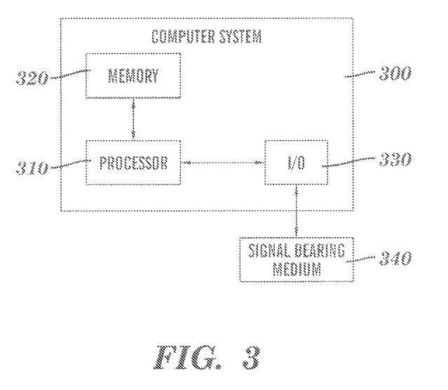

FIG. 3 illustrates an exemplary system for automatically determining optimal sessions according to exemplary embodiments. The system includes a computer 300 in contact with a signal bearing medium 340 via an input/output interface 330. The signal bearing medium 340 may include a representation of a server environment with sessions to be determined and may be implemented as, e.g., information permanently stored on non-writable storage media (e.g., read-only memory devices within a computer, such as CD-ROM disks readable by a CD-ROM drive), alterable information stored on a writeable storage media (e.g., floppy disks within a diskette drive or hard-disk drive), information conveyed to a computer by a communications medium, such as through a computer or telephone network, including wireless and broadband communications networks, such as the Internet, etc.

The computer includes a processor 310 that determines sessions for the server environment represented, e.g., on the signal bearing medium 340 and communicated to the computer via the input/output interface 330 and saves the optimal configuration of sessions, as appropriate, into the memory 320. The process for determining sessions may be embodied as a program within the memory 320 or on a signal bearing medium, such as the medium 340, and executed by the processor 310.

As described above, exemplary embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc., do not denote any order or importance, but rather the terms first, second, etc., are used to distinguish one element from another.

What is claimed is:

1. A method for automatically determining an optimal configuration of Internet Small Computer Systems Interface (iSCSI) sessions, comprising:
determining a number of iSCSI target ports and a number of iSCSI initiator ports in a configuration;
determining an ideal session count for each iSCSI initiator port in order to maximize efficiency;
traversing all iSCSI initiator ports and determining which iSCSI initiator ports have less than the ideal session count;
for those iSCSI initiator ports that have less than the ideal session count, finding the iSCSI target ports that are currently not logged into an iSCSI initiator port and attempting to establish missing sessions using iSCSI initiator ports that have fewer sessions than the ideal session count, wherein the steps of finding and attempting are repeated until a current total number of active sessions equals the number of iSCSI target ports, or there are no more eligible iSCSI initiator ports or target ports to try to attempt establishing sessions for.

2. The method of claim 1, wherein the step of determining the number of ideal session counts comprises dividing the total number of iSCSI target ports by the total number of iSCSI initiator ports, and rounding the result down to either the nearest integer of one, whichever is greater.

3. The method of claim 1, wherein if repeating the step of attempting to establish a session does not result in a session for every iSCSI target port, the method further comprises determining an additional session count.

4. The method of claim 3, wherein the additional session count is the total number of iSCSI target ports minus the number of active sessions.

5. The method of claim 3, further comprising, after determining the additional session count:
finding iSCSI initiator ports that can accept logins;
finding iSCSI target ports that have no sessions,
sending login attempts between the iSCSI initiator ports that can accept logins and the iSCSI target ports that have no sessions;
decrementing the additional session count; and
repeating the steps of finding iSCSI ports that can accept logins, finding iSCSI target ports that have no sessions, sending login attempts, and decrementing the additional session count until the additional session count is zero or until login attempts have been sent from each iSCSI initiator port.

6. The method of claim 1, further comprising determining whether there are iSCSI initiator ports which are not logged into iSCSI target ports.

7. The method of claim 6, wherein if there are iSCSI initiator ports that are not logged into iSCSI target ports, the method further comprises:
finding an iSCSI initiator port with a greater number of sessions than the ideal session count;
finding an iSCSI target port currently logged into the iSCSI initiator port with a greater number of sessions than the ideal session count;
removing an excess session from the found iSCSI target port;
logging into the found iSCSI target port from an iSCSI initiator port with zero sessions; and
repeating the steps of finding an iSCSI initiator port with a greater number of sessions than the ideal session count, finding an iSCSI target port logged into the iSCSI initiator port with a greater number of sessions than the ideal session count, removing an excess session from the found iSCSI target port, and logging into the found iSCSI target port from an iSCSI initiator port with zero sessions until all iSCSI initiator ports contain sessions to iSCSI target ports.

8. A computer program product for automatically determining an optimal configuration of Internet Small Computer Systems Interface (iSCSI) sessions, comprising a computer usable medium having a computer readable program, wherein the computer readable program, when executed on a computer, causes the computer to:
determine a number of iSCSI target ports and a number of iSCSI initiator ports in a configuration;
determine an ideal session count for each iSCSI initiator port in order to maximize efficiency;
traverse all iSCSI initiator ports and determine which iSCSI initiator ports have less than the ideal session count;
for those iSCSI initiator ports that have less than the ideal session count, find the iSCSI target ports that are currently not logged into an iSCSI initiator port and attempt to establish missing sessions using iSCSI initiator ports that have fewer sessions than the ideal session count until a current total number of active sessions equals the number of iSCSI target ports, or there are no more eligible iSCSI initiator ports or target ports to try establishing sessions for.

9. The computer program product of claim 8, wherein the computer readable program causes the computer to determine the number of ideal session counts by dividing the total number of iSCSI target ports by the total number of iSCSI initiator ports, and rounding the result down to either the nearest integer or one, whichever is greater.

10. The computer program product of claim 8, wherein if attempts to establish sessions do not result in a session for every iSCSI target port, the computer readable program further causes the computer to determine an additional session count.

11. The computer program product of claim 10, wherein the additional session count is the total number of iSCSI target ports minus the number of active sessions.

12. The computer program product of claim 10, wherein after the computer determines the additional session count, the computer readable program further causes the computer to:
find iSCSI initiator ports that can accept logins;
find iSCSI target ports that have no sessions,
send login attempts between the iSCSI initiator ports that can accept logins and the iSCSI target ports that have no sessions;
decrement the additional session count; and
repeat finding iSCSI ports that can accept logins, finding iSCSI target ports that have no sessions, sending login attempts, and decrementing the additional session count until the additional session count is zero or until login attempts have been sent from each iSCSI initiator port.

13. The computer program product of claim 8, wherein the computer readable program further causes the computer to determine whether there are iSCSI initiator ports which are not logged into iSCSI target ports.

14. The computer program product of claim 13, wherein if there are iSCSI initiator ports that are not logged into iSCSI target ports, the computer readable program further causes the computer to:
find an iSCSI initiator port with a greater number of sessions than the ideal session count;
find an iSCSI target port currently logged into the iSCSI initiator port with a greater number of sessions than the ideal session count;
remove an excess session from the found iSCSI target port;
log into the found iSCSI target port from an iSCSI initiator port with zero sessions; and
repeat finding an iSCSI initiator port with a greater number of sessions than the ideal session count, finding an iSCSI target port logged into the iSCSI initiator port with a greater number of sessions than the ideal session count, removing an excess session from the found iSCSI target port, and logging into the found iSCSI target port from an iSCSI initiator port with zero sessions until all iSCSI initiator ports contain sessions to iSCSI target ports.

15. An apparatus for automatically determining a optimal configuration of Internet Small Computer Systems Interface (iSCSI) sessions, comprising:
an input for receiving a configuration of iSCSI target ports and iSCSI initiator ports; and
a processor for determining connections between the iSCSI target ports, and iSCSI initiator ports by determining a number of iSCSI target ports and a number of iSCSI initiator ports in the configuration, determining an ideal session count for each iSCSI initiator port in order to maximize efficiency, traversing all iSCSI initiator ports and determining which iSCSI initiator ports have less than the ideal session count, and for those iSCSI initiator ports that have less than the ideal session count, finding the iSCSI target ports that are currently not logged into an iSCSI initiator port and attempting to establish missing sessions using iSCSI initiator port that have fewer sessions than the ideal session count, wherein the processor continues to find the iSCSI target ports that are currently not logged into an iSCSI initiator port and attempts to establish missing sessions until a current total number of active sessions equals the number of iSCSI target ports, or there are no more eligible iSCSI initiator ports or target ports to try to establish sessions for.

16. The apparatus of claim 15, wherein the processor determines the number of ideal session counts by dividing the total number of iSCSI target ports by the total number of iSCSI initiator ports, and rounding the result down to either the nearest integer or one, whichever is greater.

17. The apparatus of claim 15, wherein if continuing to attempt to send a login does not result in a session for every iSCSI target port, the processor determines an additional session count as the total number of iSCSI target ports minus the number of active sessions.

18. The apparatus of claim 17, wherein after determining the additional session count, the processor finds iSCSI initiator ports that can accept logins, finds iSCSI target ports that have no sessions, sends login attempts between the iSCSI initiator ports that can accept logins and the iSCSI target ports that have no sessions, and decrements the additional count until the additional session count is zero or until login attempts have been sent from each iSCSI initiator port.

19. The apparatus of claim 15, wherein the processor determines whether there are iSCSI initiator ports which are not logged into iSCSI target ports.

20. The apparatus of claim 19, wherein if there are iSCSI initiator ports that are not logged into iSCSI target ports, the processor finds an iSCSI initiator port with a greater number of sessions than the ideal session count, finds an iSCSI target port currently logged into the iSCSI initiator port with a greater number of sessions than the ideal session count, removes an excess session from the found iSCSI target port, and logs into the found iSCSI target port from an iSCSI initiator port with zero sessions until all iSCSI initiator ports contain sessions to iSCSI target ports.
